(19) United States
(12) Patent Application Publication
(10) Pub. No.: US 2009/0202427 A1
(43) Pub. Date: Aug. 13, 2009

(54) PROCESS FOR PREPARING MIXED METAL OXIDE POWDERS

(75) Inventors: Stipan Katusic, Bad Soden (DE); Guido Zimmermann, Brühl (DE); Michael Krämer, Schöneck (DE); Horst Miess, Kahl (DE); Edwin Staab, Geiselbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GMBH, Essen (DE)

(21) Appl. No.: 12/299,618

(22) PCT Filed: May 16, 2007
(86) PCT No.: PCT/EP2007/054773

§ 371 Date: Nov. 5, 2008

(30) Foreign Application Priority Data
Jun. 13, 2006 (DE) 10 2006 027 335.4

(51) Int. Cl. C01G 45/02; C01G 3/02; C01G 28/00; C01F 5/14; C01G 13/02; C01F 3/02; C01D 15/02; C01G 25/02; C01G 19/02; C01G 53/04; C01G 31/02; C01F 7/02; C01G 9/03; C01G 5/00; C01G 7/00; C01G 30/00; C01F 11/02; C01B 13/14; C01G 11/00; C01G 15/00; C01D 1/02; C01G 27/02; C01G 47/00; C01G 57/00; C01G 17/00; C01G 51/04; C01G 35/00; C01G 55/00

(52) U.S. Cl. 423/599; 423/604; 423/625; 423/617; 423/636; 423/594.18; 423/624; 423/641; 423/622; 423/608; 423/605; 423/618; 423/592.1; 423/594.19; 423/594.17; 423/600; 423/594.14

(57) ABSTRACT

Process for preparing mixed metal oxide powders Abstract Process for preparing a mixed metal oxide powder, in which oxidizable starting materials are evaporated in an evaporation zone of a reactor and oxidized in the vaporous state in an oxidation zone of this reactor, the reaction mixture is cooled after the reaction and the pulverulent solids are removed from gaseous substances, wherein at least one pulverulent metal, together with one or more combustion gases, is fed to the evaporation zone, the metal is evaporated completely in the evaporation zone under nonoxidizing conditions, an oxygen-containing gas and at least one metal compound are fed, separately or together, in the oxidation zone to the mixture flowing out of the evaporation zone, the oxygen content of the oxygen-containing gas being at least sufficient to oxidize the metal, the metal compound and the combustion gas completely.

The invention relates to a process for preparing mixed metal oxide powders.

It is known that metal oxide powders can be prepared by means of pyrogenic processes. Usually, metal compounds are evaporated and the vapours are converted to the oxides in a flame in the presence of oxygen. The disadvantage of this process lies in the availability of metal compounds whose evaporation temperature is only so great that they can be evaporated under economically viable conditions. These may, for example, be silicon tetrachloride, titanium tetrachloride or aluminium chloride, which are used to prepare the corresponding metal oxide powders on the industrial scale. Another disadvantage is that there are only a few materials for evaporators which are stable at high evaporation temperatures, often under corrosive conditions. This leads to the fact that the number of pyrogenic metal oxides preparable by this process is limited.

DE-A-10212680 and DE-A-10235758 disclose processes for preparing (doped) zinc oxide powders, in which zinc powder is first evaporated in a nonoxidizing atmosphere in an evaporation zone of a reactor, and then cooled in a nucleation zone to temperatures below the boiling point of zinc. In the nucleation zone, a dopant is optionally supplied in the form of an aerosol. Subsequently, the mixture leaving the nucleation zone is oxidized. The process is notable in that the nucleation step forms zinc species which impart particular properties to the later (doped) zinc oxide.

In this process, there is, however, the risk of formation of cold surfaces and associated condensation of metal vapour. These processes are therefore suitable mainly for low metal vapour concentrations and therefore, in terms of economic viability, only of interest for the preparation of specific (doped) zinc oxide powders.

It was therefore an object of the invention to provide a process for preparing metal oxide powders which does not have the disadvantages of the known processes. In particular, the process shall be performable inexpensively.

The invention provides a process for preparing a mixed metal oxide powder, in which
oxidizable starting materials are evaporated in an evaporation zone of a reactor and oxidized in the vaporous state in an oxidation zone of this reactor,
the reaction mixture is cooled after the reaction and the pulverulent solids are removed from gaseous substances,
   wherein
at least one pulverulent metal together with one or more combustion gases, is fed to the evaporation zone,
the metal is evaporated completely in the evaporation zone under nonoxidizing conditions,
an oxygen-containing gas and at least one metal compound are fed, together or separately, in the oxidation zone to the mixture flowing out of the evaporation zone, the oxygen content of the oxygen-containing gas being at least sufficient to oxidize the metal, the metal compound and the combustion gas completely.

In the process according to the invention, the temperatures needed for the evaporation and oxidation can be provided preferably by a flame which is formed by igniting a combustion gas with an oxygenous gas, where 0.5≦lambda≦1 in the evaporation zone and 1<lambda<10 in the oxidation zone.

The lambda value is defined as the quotient of the oxygen content of the oxygen-containing gas divided by the oxygen demand which is required for the complete oxidation of the combustion gas, of the metal and if appropriate of further metal compounds (oxidation zone), in each case in mol/h.

Suitable combustion gases may be hydrogen, methane, ethane, propane, natural gas, acetylene, carbon monoxide or mixtures of the aforementioned gases. The temperature needed to evaporate the starting materials can be provided by virtue of a suitable selection of the aforementioned gases and the oxygen content of the flame. Preference is given to using hydrogen or mixtures with hydrogen.

Particular preference is given to an embodiment in which 0.65≦lambda≦0.95 in the evaporation zone and 1.3≦lambda≦7 in the oxidation zone.

The temperatures in the evaporation zone and oxidation zone are, independently of one another, generally 500° C. to 3000° C. They are guided principally by the physical properties, for example boiling point or vapour pressure, of the starting materials to be evaporated and to be oxidized.

The temperature may also be varied by means of an inert gas.

The mean residence time of the feedstocks can be varied over the reactor dimensions and is therefore not limiting. An economically viable magnitude for the mean residence time in the evaporation zone and oxidation zone is, independently of one another, 5 ms to 30 s.

The temperatures and the residence times in evaporation zone and oxidation zone should, in the process according to the invention, be adjusted such that there is no significant sintering of the particles. The suitable conditions with regard to temperatures and residence times depend upon the metals and, if appropriate, of further metal compounds, and should be determined in each case by experiments. The process is preferably performed so as to result in nanoscale particles having a mean diameter, based on primary particles, of less than 100 nm, more preferably of less than 50 nm.

The process according to the invention can be performed at different pressures, preferably at 200 mbar to 1100 mbar. Low pressures are advantageous owing to the resulting low evaporation temperatures.

The number of metals and metal compounds used is unlimited, provided that they are evaporable and oxidizable. It is thus possible to prepare mixed metal oxides with any composition of the metal components. The process according to the invention is especially suitable for preparing binary mixed metal oxides, in which a metal is introduced into the evaporation zone and a metal compound is introduced into the oxidation zone, and ternary mixed metal oxides, in which one or two metals are introduced into the evaporation zone and one or two metal compounds are introduced into the oxidation zone.

The pulverulent metal or metal alloy may preferably be selected from the group comprising Ag, Al, As, Ba, Bi, Ca, Cd, Cu, Ga, Hg, In, Li, K, Mg, Mn, Na, Pb, Sb, Sn, Sr, Se, Te, Tl or Zn. More preferably, Zn may be used. It is also possible to use alloys of zinc and magnesium, zinc and aluminium or zinc and manganese.

The dimensions of the pulverulent metal are at first unlimited, since it is possible to control through variation of further process parameters, such as temperature and mean residence time, the evaporation of the solids. The particle size of the pulverulent metal is preferably less than 1000 μm, particular preference being given to values of less than 100 μm.

The metal compound itself may be supplied to the oxidation zone in solid form, in a form dissolved or dispersed in an aqueous or organic solvent, or in the form of vapour.

The metal component of these metal compounds may be the same as or different from the metal introduced into the evaporation zone.

In the case of the dissolved or dispersed metal compounds, the evaporation and the oxidation are effected within the oxidation zone. In this case, the type of the metal compounds is not restricted, provided that they are oxidizable and are evaporable under the conditions in the oxidation zone. It is possible to use either inorganic or organic metal compounds.

The solvents used may be water or organic solvents, such as ethanol, methanol, propanol, butanol, 2-ethylhexanol, formic acid, acetic acid or 2-ethylhexanoic acid.

More preferably, organic solvents may be used. In this case, the process according to the invention does not lead to elevated carbon contents in the mixed oxide powder.

The proportion of the metal component which is introduced into the process by the metal compound is preferably less than 25% by weight, based on the sum of metal and metal component from metal compound. More preferably, the proportion of metal compounds is not more than 10% by weight and most preferably not more than 5% by weight. The aim of the process according to the invention is to introduce maximum amounts of metal powder into the process instead of expensive metal compounds. The proportion of metal compounds used should therefore be low.

The metal compounds are preferably sprayed into the oxidation zone. In this case, at least one one-substance nozzle can generate a very fine droplet spray at pressures up to 1000 bar, mean droplet size depending on the pressure in the nozzle between <1 and 500 μm. In addition, a two-substance nozzle may be used at pressures up to 100 bar. The droplets can be generated by using one or more two-substance nozzles, in which case the gas used in the two-substance atomization may be reactive or inert.

The concentration of the metal compounds in the solutions may be varied within wide limits and depends, for example, on the solubility of the metal compound used or the proportion of the metal component from the metal compound in the later mixed oxide powder. In general, the concentration of the metal compound, based on the solution, is 1 to 30% by weight.

The metal compounds used may preferably be chlorides, nitrates, sulphates, carbonates, C₁-C₁₂-alkoxides, C₁-C₁₂-carboxylates, acetylacetonates or carbonyls with Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Sm, Sn, Sr, Ta, Tb, Ti, Tl, Tm, V, W, Y, Yb, Zn or Zr as the metal component.

More preferably, C₁-C₄-alkoxides or the C₂-C8-carboxylates of the metals Al, B, Ce, Fe, Ga, In, Li, Mg, Mn, Sb, Sn or Zn may be used.

C₁-C₄-Alkoxides include branched and unbranched, saturated alkoxides such as methoxides, ethoxides, isopropoxides, n-propoxides, n-butoxides, isobutoxides, sec-butoxides and tert-butoxides. C₂-C₈-Carboxylates include salts of branched and unbranched, saturated carboxylic acids such as acetic acid, propionic acid, butanoic acid, pentanoic acid, hexanoic acid, heptanoic acid, octanoic acid and 2-ethylhexanoic acid. C₁-C₄-Alcohols include branched and unbranched, saturated alkoxides such as methanol, ethanol, isopropanol, n-propanol, n-butanol, isobutanol, sec-butanol and tert-butanol. C₂-C₈-Carboxylic acids include branched and unbranched, saturated carboxylic acids such as acetic acid, propionic acid, butanoic acid, pentanoic acid, hexanoic acid, heptanoic acid, octanoic acid and 2-ethylhexanoic acid.

Most preferably, C₂-C₈-carboxylates of the metals Al, Ce, Mn or Zn may be used dissolved in the corresponding C₂-C₈-carboxylic acid.

When the metal compounds are used as described, the result is mixed metal oxide powders with particularly low carbon content. Moreover, soot formation in the reactor is very substantially or completely prevented.

The removal of the mixed oxide powder from the hot reaction mixture is generally preceded by a cooling process. This process can be implemented directly, for example by means of a quench gas such as air or oxygen, or indirectly, for example by means of external cooling. The mixed oxide powder can be removed from gaseous substances by means of apparatus known to those skilled in the art, for example filters.

Particular preference is given to an embodiment of the process according to the invention in which
the pulverulent metal introduced into the evaporation zone is zinc,
the pulverulent metal compound introduced into the evaporation zone is an inorganic or organic metal compound which has not more than 4 carbon atoms and is of aluminium, cerium or manganese as the metal component,
the proportion of zinc is at least 75% by weight, based on the sum of zinc and metal component from metal compound,
lambda is 0.65 to 0.95 in the evaporation zone,
lambda is 1.5 to 7 in the oxidation zone.

The invention further provides for the use of the mixed metal oxide powder prepared by the process according to the invention as a filler, as a carrier material, as a catalytically active substance, as a ceramic raw material, as a cosmetic and pharmaceutical raw material.

### EXAMPLES

### Example 1

1000 g/h of zinc powder (particle size d₅₀=25 μm) are transferred by means of a nitrogen stream (2.5 m³ (STP)/h) into an evaporation zone where a hydrogen/air flame (hydrogen 8.1 m³ (STP)/h, air 15.4 m³ (STP)/h) burns. This evaporates the zinc.

Evaporation zone conditions: lambda: 0.77, mean residence time: 1000 msec, temperature: 1100° C., pressure: 980 mbar.

Subsequently, 30 m³ (STP)/h of oxidation air are added to the reaction mixture. Separately therefrom, 1500 g/h of a solution of cerium(III) 2-ethylhexanoate in 2-ethylhexanoic acid (CeO₂ concentration: 120 g/kg) are sprayed into the oxidation zone by means of nitrogen (nozzle parameters: two-substance nozzle with nitrogen 3 m³/h, bore Ø 0.8 mm).

Oxidation zone conditions: lambda: 1.9, mean residence time: 1000 msec, temperature: 1100° C., pressure: 975 mbar.

To cool the hot reaction mixture, 120 m³ (STP)/h of quench air are added. Subsequently, the resulting powder is removed from the gas stream by filtration.

The powder contains 87.4% by weight of ZnO and 12.6% by weight of CeO₂. The BET surface area is 23 m²/g.

### Example 2

As Example 1, except using a 10 per cent solution of manganese(II) acetate in water, instead of cerium(III) 2-ethylhexanoate in 2-ethylhexanoic acid.

The powder contains 96.8% by weight of ZnO and 3.2% by weight of MnO. The BET surface area is 25 m²/g.

### Example 3 (Comparative Example)

As Example 1, except lambda>1 in the evaporation zone.

The powder contains 87.4% by weight of ZnO and 12.6% by weight of CeO₂.

The BET surface area is 9 m²/g.

### Example 4

As Example 1, except additionally using a 10 per cent solution of manganese(II) acetate in water. The powder contains 92.5% by weight of ZnO, 4.5% by weight of CeO₂ and 3.0% by weight of MnO. The BET surface area is 23 m²/g.

### Example 5

As Example 1, except using manganese instead of zinc.

The powder contains 96.5% by weight of MgO and 3.5% by weight of CeO₂. The BET surface area is 48 m²/g.

### Example 6

As Example 2, except using zinc/magnesium powder (90% by weight of Zn/10% by weight of Mg) instead of zinc.

The powder contains 84.4% by weight of ZnO, 12.5% by weight of MgO and 3.1% by weight of MnO. The BET surface area is 23 m²/g.

Feedstocks and reaction conditions are compiled in the table.

TABLE
Feedstocks and reaction conditions

| | Example | | 1 | 2 | 3 (comp.) | 4 | 5 | 6 |
|---|---|---|---|---|---|---|---|---|
| Evaporation | Metal powder | g/h | Zn | Zn | Zn | Zn | Mg | Zn/Mg*⁾ |
| zone | flow rate | | 1000 | 1000 | 1000 | 1000 | 1000 | 1000 |
| | Combustion gas | m³ (STP)/h | H₂ | H₂ | H₂ | H₂ | H₂ | H₂ |
| | flow rate | | 8.1 | 8.1 | 8.1 | 8.1 | 8.1 | 8.1 |
| | Air | m³ (STP)/h | 15.4 | 15.4 | 30 | 15.4 | 15.4 | 15.4 |
| | Lambda | | 0.77 | 0.77 | 1.5 | 0.77 | 0.72 | 0.75 |
| | Mean residence | ms | approx. 1000 | approx. 1000 | approx. 1000 | approx. 1000 | approx. 1000 | approx. 1000 |
| | time | | | | | | | |
| | Temperature | ° C. | approx. 1100 | approx. 1100 | approx. 1100 | approx. 1100 | approx. 1100 | approx. 1100 |
| Oxidation | Oxidation air | m³ (STP)/h | 30 | 30 | 15 | 30 | 30 | 30 |
| zone | Metal compound | g/h | Cerium | Manganese | Cerium | Manganese | Cerium | Manganese |
| | | | 2-ethyl- | acetate | 2-ethyl- | acetate + | 2-ethyl- | acetate |
| | | | hexanoate | | hexanoate | cerium | hexanoate | |
| | | | | | | 2-ethyl- | | |
| | | | | | | hexanoate | | |
| | flow rate | | 1500 | 1000 | 1500 | 100 + 500**⁾ | 1500 | 1000 |
| | Lambda | | 2.5 | 6.0 | not def. | 2.4 | 2.3 | 5.8 |
| | Mean residence | ms | 100 | 100 | 100 | 100 | 100 | 100 |
| | time | | | | | | | |
| | Temperature | ° C. | approx. 750 | approx. 750 | approx. 750 | approx. 750 | approx. 750 | approx. 750 |
| Quench zone | Quench gas | m³ (STP)/h | 120 | 120 | 120 | 120 | 120 | 120 |
| | Temperature | ° C. | 200 | 200 | 200 | 200 | 200 | 200 |

*⁾Zn/Mg 90/10 parts by weight;
**⁾100 g/h manganese acetate solution + 500 g/h cerium 2-ethylhexanoate solution

1. Process for preparing a mixed metal oxide powder, in which
oxidizable starting materials are evaporated in an evaporation zone of a reactor and oxidized in the vaporous state in an oxidation zone of this reactor,
the reaction mixture is cooled after the reaction and the pulverulent solids are removed from gaseous substances,
wherein
at least one pulverulent metal, together with one or more combustion gases, is fed to the evaporation zone,
the metal is evaporated completely in the evaporation zone under nonoxidizing conditions,
an oxygen-containing gas and at least one metal compound are fed, separately or together, in the oxidation zone to the mixture flowing out of the evaporation zone, the oxygen content of the oxygen-containing gas being at least sufficient to oxidize the metal, the metal compound and the combustion gas completely.

2. Process according to claim 1, wherein the temperatures needed for the evaporation and oxidation are provided by a flame which is formed by igniting a combustion gas with an oxygenous gas, where 0.5≦lambda≦1 in the evaporation zone and 1<lambda≦10 in the oxidation zone.

3. Process according to claim 1, wherein the pressure in the reactor is 200 mbar to 1100 mbar.

4. Process according to claim 1, wherein the pulverulent metal introduced into the evaporation zone is selected from the group comprising Ag, Al, As, Ba, Bi, Ca, Cd, Cu, Ga, Hg, In, Li, K, Mg, Mn, Na, Pb, Sb, Sn, Sr, Se, Te, Tl or Zn.

5. Process according to claim 1, wherein the solid starting materials have a particle size of less than 1000 μm.

6. Process according to claim 1, wherein the metal compound is introduced into the oxidation zone in dissolved, dispersed or vapour form.

7. Process according to claim 1, wherein the metal compound used is a chloride, a nitrate, a sulphate, a carbonate, a C₁-C₁₂-alkoxide, a C₁-C₁₂-carboxylate, an acetylacetonate and/or a carbonyl, with Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Sm, Sn, Sr, Ta, Tb, Ti, Tl, Tm, V, W, Y, Yb, Zn or Zr as the metal component.

8. Process according to claim 1, wherein the proportion of metal component from metal compound is not more than 25% by weight, based on the sum of metal and metal component from metal compound.

9. Process according to claim 1, wherein
the pulverulent metal introduced into the evaporation zone is zinc,
the solution of the metal compound introduced into the oxidation zone is a solution of a C₂-C₈-carboxylate or C₁-C₄-alkoxide of aluminium, cerium or manganese as the metal component in C₁-C₄-alcohols and/or C₂-C₈-carboxylic acids,
the proportion of zinc being at least 90% by weight, based on the sum of zinc and metal component from metal compound,
lambda is 0.8 to 0.95 in the evaporation zone,
lambda is 1.3 to 7 in the oxidation zone.

10. A metal oxide powder or mixed metal oxide powder prepared by the process according to claim 1 as a filler, as a carrier material, as a catalytically active substance, as a ceramic raw material, as a cosmetic and pharmaceutical raw material.
